(19) United States
(12) Patent Application Publication
(10) Pub. No.: US 2025/0249848 A1
(43) Pub. Date: Aug. 7, 2025

(54) PROTECTOR AND WIRE HARNESS

(71) Applicant: YAZAKI CORPORATION, Tokyo (JP)

(72) Inventor: Shinichi Ikeda, Makinohara-shi (JP)

(21) Appl. No.: 19/031,253

(22) Filed: Jan. 17, 2025

(30) Foreign Application Priority Data
Feb. 2, 2024 (JP) 2024-014634

(51) Int. Cl. B60R 16/02; H02G 3/30

(52) U.S. Cl. CPC B60R 16/0215; H02G 3/30

(57) ABSTRACT

A protector includes a first member having a first base wall configured to support a plurality of electric wires extending in an axial direction, and a second member having a second base wall facing the first base wall and configured to support the plurality of electric wires, wherein the first member and the second member hold and support the plurality of electric wires between the first base wall and the second base wall with the first base wall and the second base wall elastically deformed along outer shapes of the plurality of electric wires.

### CROSS-REFERENCE TO RELATED APPLICATION(S)

The present application claims priority to and incorporates by reference the entire contents of Japanese Patent Application No. 2024-014634 filed in Japan on Feb. 2, 2024.

### BACKGROUND OF THE INVENTION

### 1. Field of the Invention

The present invention relates to a protector and a wire harness.

### 2. Description of the Related Art

As a technique related to a conventional protector of a wire harness, for example, Japanese Patent Application Laid-open No. 2021-114401 A discloses a protector including a first member having a first base wall configured to support a plurality of electric wires extending in an axial direction, and a second member having a second base wall facing the first base wall, and housing the plurality of electric wires between the second base wall and the first base wall.

In the protector described in Japanese Patent Application Laid-open No. 2021-114401 A described above, for example, there is room for further improvement in terms of enhancing a holding force for the plurality of electric wires.

### SUMMARY OF THE INVENTION

The present invention has been made in view of the above circumstances, and an object thereof is to provide a protector and a wire harness both capable of enhancing a holding force for a plurality of electric wires.

In order to achieve the above mentioned object, a protector according to one aspect of the present invention includes a first member having a first base wall configured to support a plurality of electric wires extending in an axial direction; and a second member having a second base wall facing the first base wall and configured to support the plurality of electric wires, wherein the first member and the second member hold and support the plurality of electric wires between the first base wall and the second base wall with the first base wall and the second base wall elastically deformed along outer shapes of the plurality of electric wires.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a wire harness to which a protector according to an embodiment is applied;

FIG. 2 is an exemplary perspective view of the protector according to the embodiment, illustrating a state of a first base wall and a second base wall before being elastically deformed;

FIG. 3 is an exemplary cross-sectional view of the protector according to the embodiment;

FIG. 4 is an exemplary perspective view of a wire harness to which a protector according to a first modification is applied;

FIG. 5 is an exemplary perspective view of the protector according to the first modification, illustrating a state of a first base wall and a second base wall before being elastically deformed;

FIG. 6 is an exemplary cross-sectional view of the protector according to the first modification;

FIG. 7 is an exemplary perspective view of a wire harness to which a protector according to a second modification is applied;

FIG. 8 is an exemplary perspective view of the protector according to the second modification, illustrating a state of a first base wall and a second base wall before being elastically deformed; and

FIG. 9 is an exemplary cross-sectional view of the protector according to the second modification.

### DETAILED DESCRIPTION OF THE PREFERRED EMBODIMENTS

Hereinafter, an embodiment and modifications according to the present invention will be described in detail based on the drawings. Note that the present invention is not limited by the following embodiment and modifications. Constituent elements in the following embodiment and modifications include those that can be easily replaced by those skilled in the art or those that are substantially the same.

In the embodiment and modifications disclosed below, similar constituent elements are included. These similar constituent elements are given common reference signs in the following description, and the redundant description is omitted. In the present specification, ordinal numbers are used exclusively to distinguish components, members, parts, positions, directions, and the like, and do not indicate order or priority.

### Embodiment

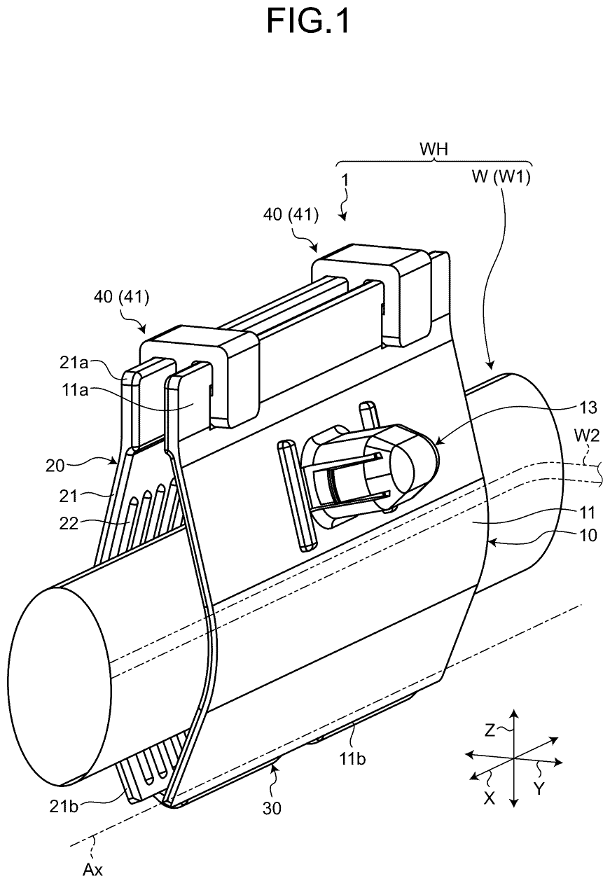

FIG. 1 is a perspective view of a wire harness WH to which a protector 1 according to an embodiment is applied. The protector 1 of the present embodiment illustrated in FIG. 1 is incorporated in the wire harness WH that is routed in a vehicle such as an automobile. For the purpose of connection between devices installed in a vehicle, the wire harness WH is used for connecting a plurality of electric wires W tied up in bundle as a collective component for use in power supply and signal communication, to each device by a connector or the like, for example. The wire harness WH of the present embodiment includes the plurality of electric wires W having conductivity and the protector 1 that holds the plurality of electric wires W. Moreover, the wire harness WH may further include various constituent components such as a grommet, an electrical junction box, and a fixing tool.

In the following description, of a first direction, a second direction, and a third direction that intersect one another, the first direction is referred to as an “axial direction X”, the second direction is referred to as a “width direction Y”, and the third direction is referred to as a “height direction Z”. Here, the axial direction X, the width direction Y, and the height direction Z are substantially orthogonal to one another. The axial direction X is typically parallel with an extending direction of the plurality of electric wires W, the insertion direction of the plurality of electric wires W with respect to the protector 1, the longitudinal direction (extending direction) of the protector 1, and the like. The width direction Y is typically parallel with the width direction of the protector 1, a stacking direction of a first member 10 and a second member 20, which will be described later, of the protector 1, and the like. The height direction Z is typically parallel with the height direction (up-down direction) of the protector 1, and the like. Note that the directions used in the following description will be described as directions with the protector 1 mounted to a vehicle, unless otherwise specified.

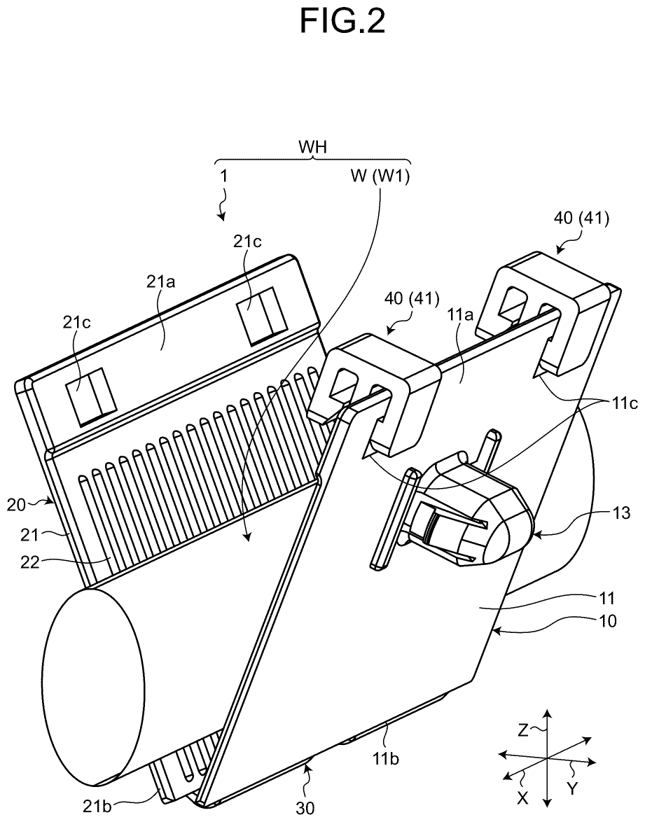

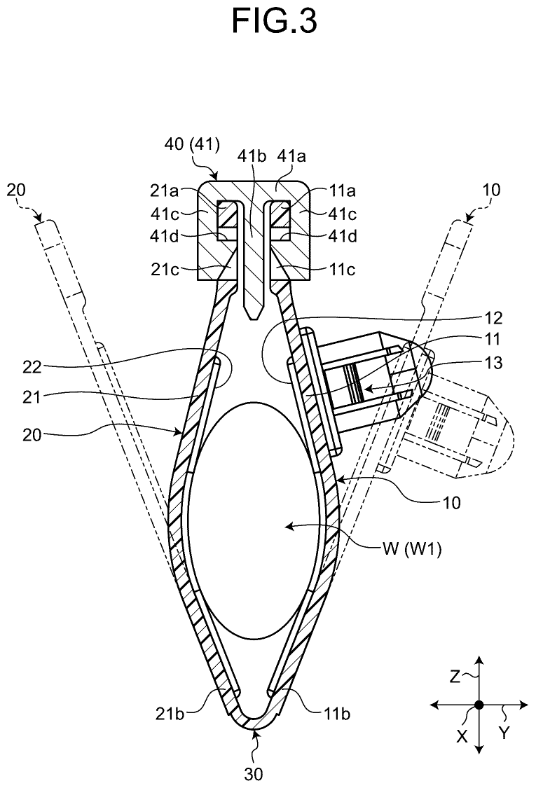

As illustrated in FIG. 1, the wire harness WH includes, for example, a trunk line portion W1 extending in the axial direction X, and a branch line portion W2 branching off the trunk line portion W1. The trunk line portion W1 is a main portion of the wire harness WH, and is formed by tying up the plurality of electric wires W in a bundle. For example, the trunk line portion W1 may include a portion of the wire harness WH where the largest number of the electric wires W is tied up in a bundle, or may include a portion of the wire harness WH where the wire harness WH has the largest outer diameter. In FIG. 1, FIG. 2, FIG. 3, and the like, the plurality of electric wires W constituting the trunk line portion W1 are illustrated in a simplified manner for convenience.

The branch line portion W2 is a sub-harness portion of the wire harness WH, and is formed of one electric wire W or a plurality of electric wires W branching off the trunk line portion W1. In the present embodiment, the wire harness WH includes, for example, a plurality of branch line portions W2. The plurality of branch line portions W2 are bent in the width direction Y from the trunk line portion W1 extending in the axial direction X, and are drawn and routed outside at positions shifted from the protector 1 in the axial direction X. In the present embodiment, the wire harness WH includes one protector 1; however, the present invention is not limited to this example, and for example, a plurality of protectors 1 may be spaced away from each other in the axial direction X, and a plurality of branch line portions W2 may be drawn in the width direction Y at positions between the plurality of protectors 1.

For example, the plurality of electric wires W each extend linearly in the axial direction X and elongate to have approximately the same diameter in the axial direction X (direction in which the plurality of electric wires W extend). Each electric wire W includes a core wire and an insulating sheath that covers the core wire. The electric wire W has, for example, a cross-sectional shape of the core wire (shape of a cross section intersecting the axial direction X) formed in a substantially circular shape, and a cross-sectional shape of the insulating sheath formed in a substantially annular shape so as to be formed in a substantially circular cross-sectional shape as a whole. In the present embodiment, the plurality of electric wires W are equal in outer diameter to each other; however, the present invention is not limited to this example, and for example, an electric wire W that constitutes the branch line portion W2 may be different in outer diameter from a plurality of electric wires W that constitute the trunk line portion W1.

The protector 1 includes, for example, the first member 10, the second member 20, a hinge 30, and a lock portion 40. For example, the first member 10 and the second member 20 are formed of a flexible pliable member having flexibility such as synthetic resin. The first member 10 and the second member 20 are formed in a plate shape, and are integrated with each other by a clip structure of the lock portion 40 (described later) with the above-described plurality of electric wires W interposed between the first member 10 and the second member 20. The protector 1 is formed in a flat shape thinned in the width direction Y as a whole in such a manner that the first member 10 and the second member 20 are mounted together.

The hinge 30 connects the second member 20 to the first member 10 so as to allow the second member 20 to rotate. The hinge 30 has, for example, a rotation center Ax (rotation axis) extending in the axial direction X. The second member 20 is turnable between a closed position (see FIG. 1) where the second member 20 closes an insertion space of the protector 1 in which the plurality of electric wires W are inserted and an open position (see FIG. 2) where the second member 20 opens the insertion space, by rotation about the rotation center Ax of the hinge 30. FIG. 2 illustrates a state in which an angle between the first member 10 and the second member 20 at the open position is about 45 degrees, for convenience; however, the present invention is not limited to this example, and for example, the angle between the first member 10 and the second member 20 at the open position may include about 90 degrees, about 180 degrees, and other angles.

FIG. 2 is a perspective view of the protector 1, illustrating a state of a first base wall 11 and a second base wall 21 before being elastically deformed. As illustrated in FIG. 2, the first member 10 includes, for example, the first base wall 11, a plurality of beads 12 (see FIG. 3), and a clamp 13. The first base wall 11 is formed in, for example, a flat plate shape and extends in the axial direction X. The first base wall 11 supports the plurality of electric wires W from one side in the width direction Y. The first base wall 11 is a structural element that defines the insertion space in the protector 1. The insertion space is a space in which the trunk line portion W1 constituted of the plurality of electric wires W is inserted and routed in the axial direction X.

The plurality of beads 12 (see FIG. 3) are formed integrally with the first base wall 11, for example. The plurality of beads 12 protrude from the first base wall 11 toward the other side (the plurality of electric wires W side) in the width direction Y, and extend in the direction (height direction Z in FIG. 3) intersecting the axial direction X. The plurality of beads 12 are spaced away from each other in the axial direction X, and for example, the plurality of beads 12 are arranged in contact with the plurality of electric wires W, and thus function as a slip stopper for the plurality of electric wires W.

The clamp 13 is provided on a surface of the first base wall 11 opposite to the plurality of beads 12, for example. The clamp 13 is provided at a substantially center of the first base wall 11, and protrudes from the first base wall 11 toward the one side in the width direction Y. The clamp 13 functions as a portion that fixes the protector 1 to a fixing target part of a vehicle.

The second member 20 includes, for example, the second base wall 21 and a plurality of beads 22. The second base wall 21 is formed in, for example, a flat plate shape and extends in the axial direction X. The second base wall 21 supports the plurality of electric wires W from the other side in the width direction Y. The second base wall 21 is a structural element that defines the insertion space in the protector 1. The insertion space is a space in which the trunk line portion W1 constituted of the plurality of electric wires W is inserted and routed in the axial direction X. For example, the plurality of electric wires W are exposed from a section of the trunk line portion W1 not covered with the second base wall 21 and the first base wall 11.

The plurality of beads 22 are formed integrally with the second base wall 21, for example. The plurality of beads 22 protrude from the second base wall 21 toward the one side (the plurality of electric wires W side) in the width direction Y, and extend in the direction (height direction Z in FIG. 3) intersecting the axial direction X. The plurality of beads 22 are spaced away from each other in the axial direction X, and for example, the plurality of beads 22 are arranged in contact with the plurality of electric wires W, and thus function as a slip stopper for the plurality of electric wires W. For example, the plurality of beads 22 may be provided to be shifted from the plurality of beads 12 in the axial direction X, or may be provided in alignment with the plurality of beads 12 in the width direction Y.

FIG. 3 is a cross-sectional view of the protector 1. As illustrated in FIG. 3, the first member 10 has a plurality of through-holes 11c passing through the first base wall 11 in the width direction Y, and the second member 20 has a plurality of through-holes 21c passing through the second base wall 21 in the width direction Y. In the present embodiment, the plurality of through-holes 11c (see FIG. 2) are spaced away from each other in the axial direction X in an end portion 11a of the first base wall 11 on one side in the height direction Z. In addition, the plurality of through-holes 21c are spaced away from each other in the axial direction X in an end portion 21a of the second base wall 21 on the one side in the height direction Z.

In the present embodiment, the end portion 11a is an end portion opposite to an end portion 11b on the hinge 30 side of the first member 10 (first base wall 11), and the end portion 21a is an end portion opposite to an end portion 21b on the hinge 30 side of the second member 20 (second base wall 21). The plurality of through-holes 11c provided in the end portion 11a and the plurality of through-holes 21c provided in the end portion 21a overlap in the width direction Y. The above-described lock portion 40 is fitted into the plurality of through-holes 11c and the plurality of through-holes 21c.

The lock portion 40 locks the second member 20 to the first member 10 at the closed position (see FIG. 3), for example. In the present embodiment, the lock portion 40 includes a clip member 41 provided separately from the first member 10 and the second member 20. A pair of clip members 41 are spaced apart from each other in the axial direction X, correspondingly to the plurality of through-holes 11c and 21c. The pair of clip members 41 each include, for example, a base wall 41a, a middle wall 41b, a pair of side walls 41c, and a pair of claws 41d.

The base wall 41a is a portion of the clip member 41 extending between the end portion 11a of the first member 10 and the end portion 21a of the second member 20 in the width direction Y. The base wall 41a supports the two end portions 11a and 21a from the one side in the height direction Z. The middle wall 41b is a portion of the clip member 41 protruding from a center of the base wall 41a in the width direction Y toward the other side in the height direction Z, and is inserted between the two end portions 11a and 21a. In the present embodiment, a length of the middle wall 41b in the height direction Z is longer than a length of the pair of side walls 41c in the height direction Z, so that the middle wall 41b protrudes into the above-described insertion space in the protector 1.

The pair of side walls 41c are portions of the clip member 41 respectively protruding from two end portions of the base wall 41a in the width direction Y toward the other side in the height direction Z. The pair of side walls 41c support the two end portions 11a and 21a from both the sides in the width direction Y. The pair of claws 41d are portions of the clip member 41 protruding from the other end portions of the pair of side walls 41c in the height direction Z toward the center side in the width direction Y, that is, toward the through-holes 11c and 21c. The pair of claws 41d have locking surfaces facing edges of the through-holes 11c and 21c in the height direction Z, and when the locking surfaces and the edges of the through-holes 11c and 21c are locked in the height direction Z while the second member 20 is at the closed position, the second member 20 is locked to the first member 10 at the closed position.

In the present embodiment, the first member 10 and the second member 20 are mounted together so as to hold and support the plurality of electric wires W between the first base wall 11 and the second base wall 21 with the first base wall 11 and the second base wall 21 elastically deformed along outer shapes of the plurality of electric wires W. That is, in the present embodiment, the first base wall 11 and the second base wall 21 are separated from each other in the width direction Y by a width of the plurality of electric wires W and are curved in a substantially U shape opened toward the center side (the plurality of electric wires W side) in the width direction Y, in the state in which the first member 10 and the second member 20 are mounted together. As a result, an elastic restoring force is generated in the first base wall 11 and the second base wall 21, a surface pressure between the first base wall 11 and the plurality of electric wires W increases, and a surface pressure between the second base wall 21 and the plurality of electric wires W increases, so that a holding force for the plurality of electric wires W is increased.

In the present embodiment, the above-described pair of claws 41d of the clip member 41 are locked to the plurality of through-holes 11c and 21c in the state in which the elastic restoring force is generated in the first base wall 11 and the second base wall 21. While the pair of claws 41d and the plurality of through-holes 11c and 21c are locked, movement of the first member 10 and the second member 20 away from each other in the width direction Y, that is, movement of the first member 10 and the second member 20 toward the open position indicated by a two-dot chain line in FIG. 3 is restricted, so that the state in which the surface pressure between the first base wall 11 and the plurality of electric wires W increases and the state in which the surface pressure between the second base wall 21 and the plurality of electric wires W increases are maintained.

In the present embodiment, for example, the pair of clip members 41 are attached to the first member 10 in a state where the claws 41d of the pair of clip members 41 on the one side in the width direction Y are locked to the plurality of through-holes 11c of the first member 10 (see FIG. 2). Next, the first base wall 11 and the second base wall 21 are elastically deformed (curved) along the outer shapes of the plurality of electric wires W and, in this state, the claws 41d of the pair of clip members 41 on the other side in the width direction Y are locked to the plurality of through-holes 21c of the second member 20. At this time, in the present embodiment, the end portion 21a of the second member 20 is slipped and inserted into the opening between the claws 41d of the pair of clip members 41 on the other side in the width direction Y and the middle walls 41b of the pair of clip members 41, from the other side in the height direction Z, for example. Through these steps, the second member 20 can be mounted to the first member 10 with the pair of clip members 41.

As described above, the protector 1 and the wire harness WH of the present embodiment include the first member 10 having the first base wall 11 configured to support the plurality of electric wires W extending in the axial direction X, and the second member 20 having the second base wall 21 facing the first base wall 11 and configured to support the plurality of electric wires W, wherein the first member 10 and the second member 20 hold and support the plurality of electric wires W between the first base wall 11 and the second base wall 21 with the first base wall 11 and the second base wall 21 elastically deformed along the outer shapes of the plurality of electric wires W. According to the protector 1 and the wire harness WH of this configuration, it is possible to hold the plurality of electric wires W in such a manner that, for example, the plurality of electric wires W are held and supported between the first base wall 11 and the second base wall 21 with the first base wall 11 and the second base wall 21 elastically deformed along the outer shapes of the plurality of electric wires W. According to the protector 1 and the wire harness WH, as a result, it is possible to enhance the holding force for the plurality of electric wires W, and it is therefore possible to further thin the first member 10 and the second member 20 in the width direction Y.

The protector 1 and the wire harness WH of the present embodiment further include the hinge 30 connecting the second member 20 to the first member 10 so as to allow the second member 20 to rotate about the rotation center Ax extending in the axial direction X, and the lock portion 40 configured to lock the end portions 11a and 21a of the first member 10 and second member 20 opposite to the hinge 30 with the first base wall 11 and the second base wall 21 elastically deformed. According to the protector 1 and the wire harness WH of this configuration, it is possible to connect the second member 20 to the first member 10 by using the hinge 30 such that the second member 20 is turnable between the closed position (see FIG. 1) and the open position (see FIG. 2), and it is therefore possible to maintain (keep) the state in which the first base wall 11 and the second base wall 21 are elastically deformed, by using the lock portion 40 locking the second member 20 at the closed position, for example.

In the protector 1 and the wire harness WH of the present embodiment, the lock portion 40 includes the clip member 41 provided separately from the first member 10 and the second member 20. According to the protector 1 and the wire harness WH of this configuration, it is possible to relatively easily maintain (keep) the state in which the first base wall 11 and the second base wall 21 are elastically deformed, by using the clip member 41, for example.

In the protector 1 and the wire harness WH of the present embodiment, the first base wall 11 and the second base wall 21 each includes the plurality of beads 12 and 22, respectively that extend in the direction (height direction Z) intersecting the axial direction X, are spaced away from each other in the axial direction X, and are brought into contact with the plurality of electric wires W. According to the protector 1 and the wire harness WH of this configuration, it is possible to cause the plurality of beads 12 and 22 to function as a slip stopper for the plurality of electric wires W, and it is therefore possible to restrain the movement of the plurality of electric wires W relative to the first member 10 and the second member 20 in the axial direction X, for example.

### First Modification

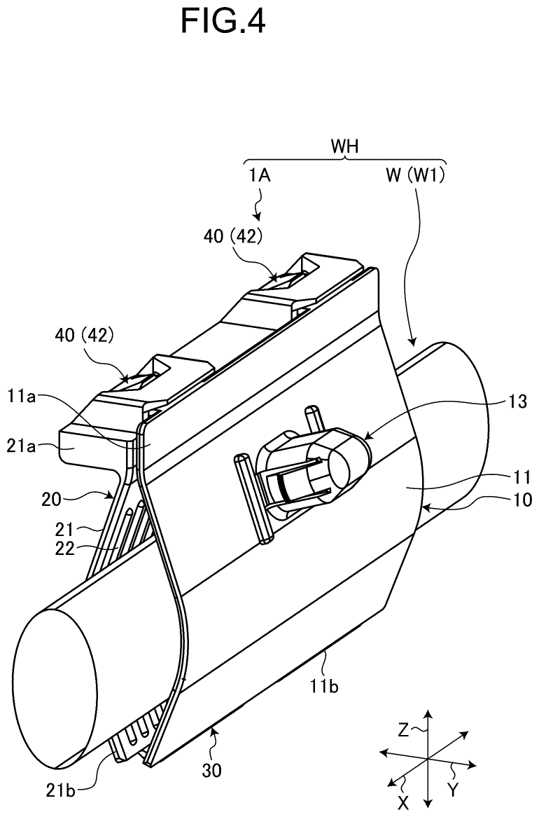

FIG. 4 is a perspective view of a wire harness WH to which a protector 1A according to a first modification is applied. The protector 1A illustrated in FIG. 4 has a configuration similar to that of the protector 1 of the above embodiment. Thus, the protector 1A can exhibit operation and effect similar to those of the protector 1 of the above embodiment, based on this similar configuration.

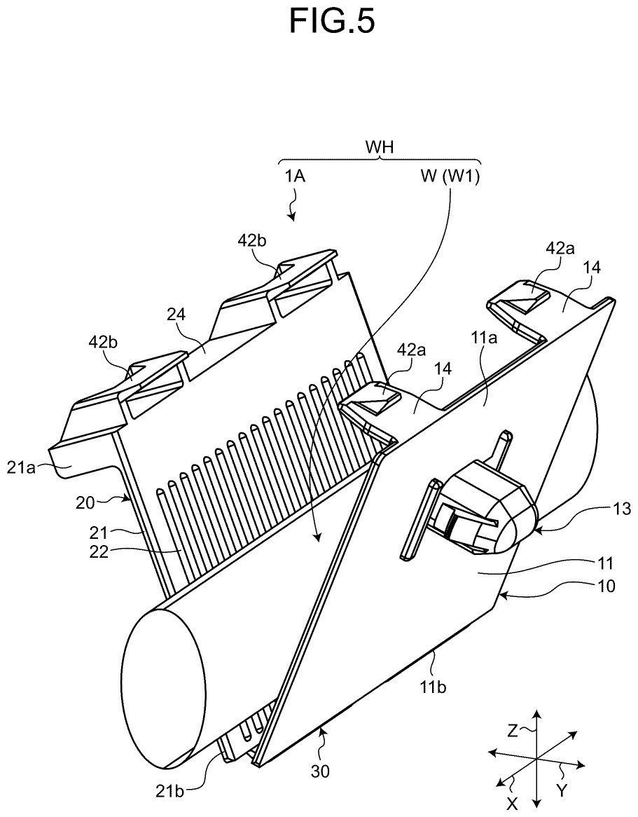

As illustrated in FIG. 4, however, the present modification is different from the above embodiment in that a lock portion 40 includes a locking mechanism 42 provided integrally with a first member 10 and a second member 20. The locking mechanism 42 locks the second member 20 to the first member 10 at a closed position (see FIG. 4). For example, a pair of locking mechanisms 42 are spaced away from each other in the axial direction X. The pair of locking mechanisms 42 each include, for example, a locking portion 42a (see FIG. 5) and a locked portion 42b.

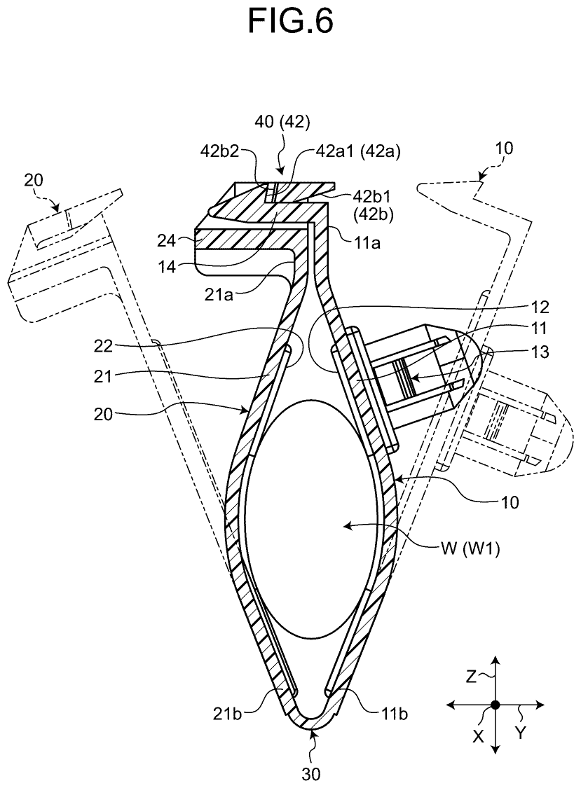

FIG. 5 is an exemplary perspective view of the protector 1A according to the first modification, illustrating a state of a first base wall 11 and a second base wall 21 before being elastically deformation, and FIG. 6 is a cross-sectional view of the protector 1A according to the first modification. As illustrated in FIGS. 5 and 6, the locking portions 42a are provided on outer surfaces of protrusions 14 protruding from an end portion 11a of the first base wall 11 opposite to a hinge 30, toward the other side in the width direction Y, for example. The locking portions 42a are each formed in, for example, a claw shape to be inserted into the corresponding locked portion 42b in the width direction Y, and each have a locking surface 42a1 (see FIG. 6) facing the corresponding locked portion 42b in the width direction Y.

The locked portions 42b are provided on an outer surface of a protrusion 24 protruding from an end portion 21a of the second base wall 21 opposite to the hinge 30, toward the other side in the width direction Y, for example. The locked portions 42b are each formed in, for example, a shape of a locking hole into which the corresponding locking portion 42a is inserted in the width direction Y, and at an entry-side open end of each locked portion 42b, a tapered surface 42b1 (see FIG. 6) is provided so as to be inclined toward the one side in the height direction Z as extending toward the one side in the width direction Y. At an exit-side open end of each locked portion 42b, a locked surface 42b2 (see FIG. 6) is provided so as to face the locking surface 42al of the corresponding locking portion 42a in the width direction Y, and when the locked surface 42b2 and the locking surface 42a1 are locked in the width direction Y, the second member 20 is locked to the first member 10.

In the present modification, the locking portions 42a of the above-described locking mechanisms 42 are locked to the locked portions 42b in a state in which an elastic restoring force is generated in the first base wall 11 and the second base wall 21. While the locking portions 42a and the locked portions 42b are locked, movement of the first member 10 and the second member 20 away from each other in the width direction Y, that is, movement of the first member 10 and the second member 20 toward an open position indicated by a the two-dot chain line in FIG. 6 is restricted, so that a state in which a surface pressure between the first base wall 11 and the plurality of electric wires W increases and a state in which a surface pressure between the second base wall 21 and the plurality of electric wires W increases are maintained.

As described above, in the protector 1A and the wire harness WH of the present modification, the lock portion 40 includes the locking mechanism 42 provided integrally with the first member 10 and the second member 20. According to the protector 1A and the wire harness WH of this configuration, it is possible to relatively easily maintain (keep) the state in which the first base wall 11 and the second base wall 21 are elastically deformed, by using the locking mechanism 42, for example. Note that in the present modification, the case where the first member 10 is provided with the locking portions 42a and the second member 20 is provided with the locked portions 42b has been exemplified; however, the present invention is not limited to this example, and for example, the first member 10 may be provided with the locked portions 42b and the second member 20 may be provided with the locking portions 42a.

### Second Modification

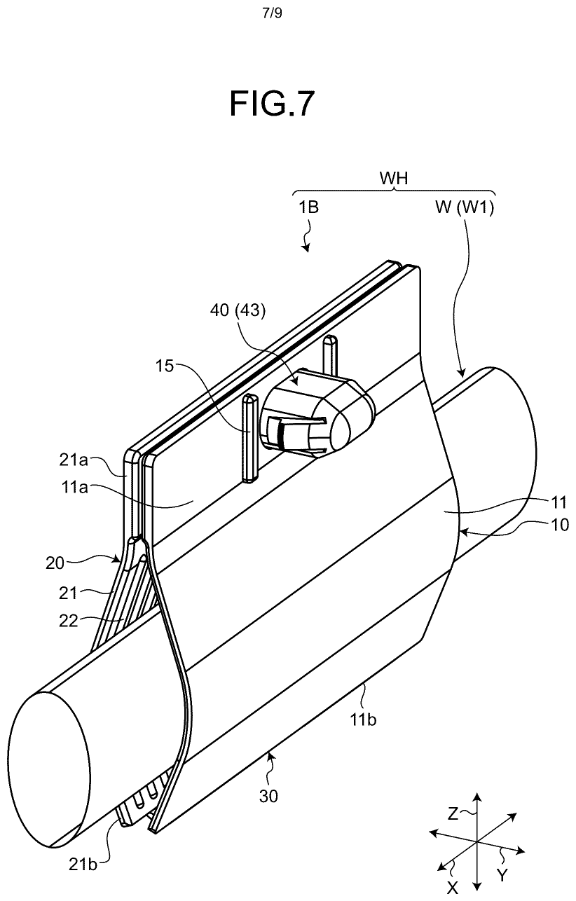

FIG. 7 is a perspective view of a wire harness WH to which a protector 1B according to a second modification is applied. The protector 1B illustrated in FIG. 7 has a configuration similar to that of the protector 1 of the above embodiment. Thus, the protector 1B can exhibit operation and effect similar to those of the protector 1 of the above embodiment, based on this similar configuration.

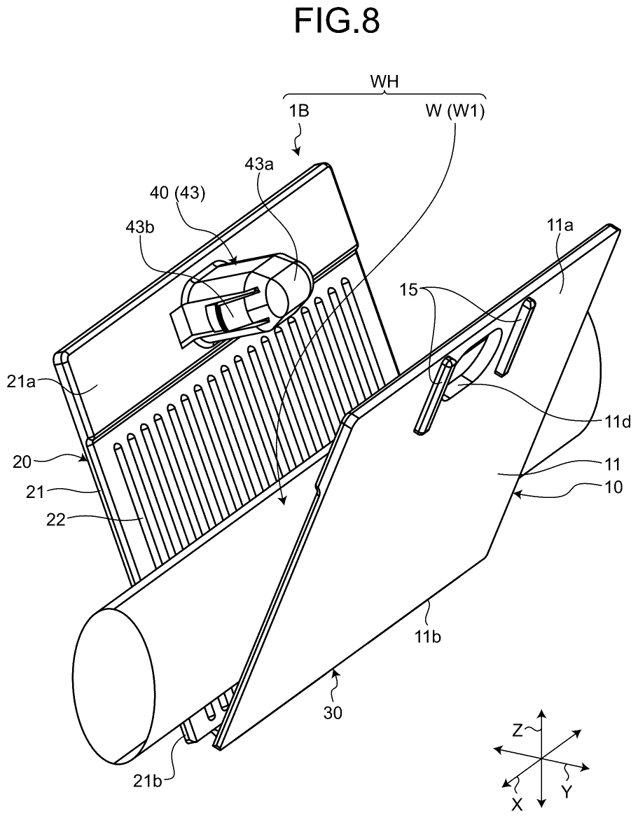

As illustrated in FIG. 7, however, the present modification is different from the above embodiment in that a lock portion 40 includes a clamp 43 that fixes a first member 10 and a second member 20 to a fixing target part. The clamp 43 of the present modification corresponds to combined use (shared use) of the clamp 13 of the above embodiment and the first modification and the lock portion 40. The clamp 43 has a function of locking the second member 20 to the first member 10 at a closed position (see FIG. 7). The clamp 43 includes, for example, a clip 43a (see FIG. 8) to be fitted into a through-hole of the fixing target part.

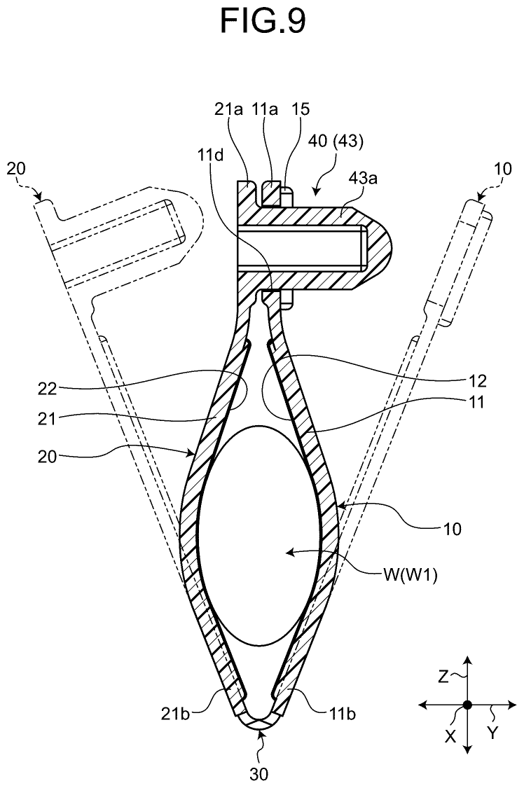

FIG. 8 is an exemplary perspective view of the protector 1B according to the second modification, illustrating a state of a first base wall 11 and a second base wall 21 before being elastically deformed, and FIG. 9 is a cross-sectional view of the protector 1B according to the second modification. As illustrated in FIGS. 8 and 9, the clip 43a is provided on an end portion 21a of the second base wall 21 opposite to a hinge 30, and protrudes from the end portion 21a toward the one side (the first base wall 11 side) in the width direction Y, for example. A pair of locking portions 43b each protruding in a claw shape (umbrella shape) are provided at two end portions of the clip 43a in the axial direction X. The pair of locking portions 43b are formed in a tapered shape inclined toward the center side in the axial direction X (a side where the locking portions 43b come close to each other) as extending toward the one side in the width direction Y.

In an end portion 11a of the first base wall 11 opposite to the hinge 30, an opening 11d into which the clip 43a is inserted is provided. The opening 11d is a through-hole passing through the first base wall 11 in the width direction Y. A pair of ribs 15 are provided on two sides of the opening 11d of the end portion 11a in the axial direction X. The pair of ribs 15 extend in the height direction Z. In the present modification, for example, the clip 43a is fitted into the through-hole of the fixing target part, and the plate-shaped fixing target part is sandwiched between the pair of locking portions 43b of the clip 43a and the pair of ribs 15, so that the protector 1B is fixed to the fixing target part, and the second member 20 is locked to the first member 10.

In the present modification, the above-described pair of locking portions 43b of the clamp 43 are locked to the fixing target part in a state in which an elastic restoring force is generated in the first base wall 11 and the second base wall 21. While the pair of locking portions 43b and the fixing target part are locked, movement of the first member 10 and the second member 20 away from each other in the width direction Y, that is, movement of the first member 10 and the second member 20 toward an open position indicated a the two-dot chain line in FIG. 9 is restricted, so that a state in which a surface pressure between the first base wall 11 and the plurality of electric wires W increases and a state in which a surface pressure between the second base wall 21 and the plurality of electric wires W increases are maintain.

As described above, in the protector 1B and the wire harness WH of the present modification, the lock portion 40 includes the clamp 43 configured to fix the first member 10 and the second member 20 to the fixing target part. According to the protector 1B and the wire harness WH of this configuration, it is possible to relatively easily maintain (keep) the state in which the first base wall 11 and the second base wall 21 are elastically deformed, by using the clamp 43, for example, and it is therefore possible to reduce the labor, cost, and others required for manufacturing the protector 1B and the wire harness WH, by combining (sharing) the clamp 43 and the lock portion 40.

In the above embodiment and modifications, the case where the plurality of beads 12 and 22 are provided on the first base wall 11 and the second base wall 21, respectively, has been exemplified; however, the present invention is not limited to this example, and for example, the plurality of beads 12 or the plurality of beads 22 may be provided on only one of the first base wall 11 and the second base wall 21.

Although the embodiment and modifications of the present invention have been exemplified above, the above embodiment and the modifications are merely examples, and are not intended to limit the scope of the invention. The above embodiment and modifications can be implemented in various other forms, and various omissions, substitutions, combinations, and changes can be made without departing from the gist of the invention. In addition, specifications such as constitutions, shapes, and the like (structure, type, direction, form, size, length, width, thickness, height, number, arrangement, position, material, and the like) can be appropriately changed and implemented.

The protector and the wire harness according to the present embodiment can hold the plurality of electric wires in such a manner that the plurality of electric wires are held and supported between the first base wall and the second base wall with the first base wall and the second base wall elastically deformed along the outer shapes of the plurality of electric wires. As a result, the protector and the wire harness can exhibit an advantageous effect of enhancing a holding force for the plurality of electric wires.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protector comprising:
a first member having a first base wall configured to support a plurality of electric wires extending in an axial direction; and
a second member having a second base wall facing the first base wall and configured to support the plurality of electric wires, wherein
the first member and the second member hold and support the plurality of electric wires between the first base wall and the second base wall with the first base wall and the second base wall elastically deformed along outer shapes of the plurality of electric wires.

2. The protector according to claim 1, further comprising:
a hinge connecting the second member to the first member so as to allow the second member to rotate about a rotation center extending in the axial direction; and
a lock portion configured to lock end portions of the first member and second member opposite to the hinge with the first base wall and the second base wall elastically deformed.

3. The protector according to claim 2, wherein
the lock portion includes a clip member provided separately from the first member and the second member.

4. The protector according to claim 2, wherein
the lock portion includes a locking mechanism provided integrally with the first member and the second member.

5. The protector according to claim 2, wherein
the lock portion includes a clamp configured to fix the first member and the second member to a fixing target part.

6. The protector according to claim 1, wherein
at least one of the first base wall and the second base wall includes a plurality of beads that extend in a direction intersecting the axial direction, are spaced away from each other in the axial direction, and are brought into contact with the plurality of electric wires.

7. The protector according to claim 2, wherein
at least one of the first base wall and the second base wall includes a plurality of beads that extend in a direction intersecting the axial direction, are spaced away from each other in the axial direction, and are brought into contact with the plurality of electric wires.

8. A wire harness comprising:
a plurality of electric wires extending in an axial direction; and
a protector configured to hold the plurality of electric wires, wherein
the protector includes:
a first member having a first base wall configured to support the plurality of electric wires; and
a second member having a second base wall facing the first base wall and configured to support the plurality of electric wires, and
the first member and the second member hold and support the plurality of electric wires between the first base wall and the second base wall with the first base wall and the second base wall elastically deformed along outer shapes of the plurality of electric wires.
